(19) United States
(12) Patent Application Publication
(10) Pub. No.: US 2025/0003153 A1
(43) Pub. Date: Jan. 2, 2025

(54) CELLULOSIC STRUCTURES, METHODS FOR MANUFACTURING CELLULOSIC STRUCTURES, AND METHODS FOR REMOVING POLYMERIC COATINGS FROM CELLULOSIC STRUCTURES

(71) Applicant: WestRock MWV, LLC, Atlanta, GA (US)

(72) Inventors: Steven G. BUSHHOUSE, Quinton, VA (US); Rahul BHARDWAJ, Glen Allen, VA (US); Gary P. FUGITT, Rockville, VA (US); Scott E. GINTHER, Moseley, VA (US); Justin L. BENNETT, Williamsburg, VA (US); Brooks H. POUNCEY, Atlanta, GA (US); Courtney JOHNSON, Midlothian, VA (US); Chitai C, YANG, Glen Allen, VA (US)

(21) Appl. No.: 18/700,615

(22) PCT Filed: Oct. 11, 2022
(86) PCT No.: PCT/US2022/046307

§ 371 Date: Apr. 11, 2024

Related U.S. Application Data
(60) Provisional application No. 63/254,931, filed on Oct. 12, 2021.

(51) Int. Cl. D21H 19/82; B32B 43/00; B65D 3/06; B65D 25/14; D21C 5/02; D21H 11/04; D21H 19/22; D21H 19/28; D21H 19/38; D21H 19/54; D21H 21/16

(52) U.S. Cl. CPC D21H 19/826; B32B 43/006; B65D 3/06; B65D 25/14; D21C 5/02; D21H 11/04; D21H 19/22; D21H 19/28; D21H 19/385; D21H 19/54; D21H 21/16; B32B 2307/31; B32B 2307/4026; B32B 2307/7166; B32B 2307/718; B32B 2307/7265; B32B 2307/748; B32B 2310/0409; B32B 2317/12; B32B 2323/046; B32B 2367/00; B32B 2439/02

(57) ABSTRACT

A cellulosic structure includes a paperboard substrate having a first surface and a second surface. The cellulosic structure further includes a barrier layer applied to the first surface of the paperboard substrate. The cellulosic structure further includes a release layer positioned between the first surface of the paperboard substrate and the barrier layer. The release layer is water soluble.

### FIELD

The present application relates to the field of cellulosic structures and, more particularly, cellulosic structures having a releasable coating disposed between a paperboard substrate and a polymeric layer, methods for manufacturing cellulosic structures and methods for removing polymeric coatings from cellulosic structures.

### BACKGROUND

Paperboard is used in various packaging applications, such as containers. For example, paperboard is used in the food and beverage industry to form paperboard cups for holding hot or cold beverages.

Paperboard cups for holding hot beverages typically require enhanced liquid barrier properties on an interior surface of the cup to minimize absorption of liquid from the beverage into the paperboard substrate. Paperboard cups for holding cold beverages typically require enhanced liquid barrier properties on an interior surface of the cup to minimize absorption of liquid from the beverage into the paperboard substrate and on an exterior surface of the cup to minimize absorption of liquid from condensate into the paperboard substrate.

The paperboard is typically heat sealable, making it possible to form paperboard cups on a cup machine. Polyethylene (PE) extrusion coated paperboard currently still dominates in such applications by providing both good barrier and good heat sealing properties. However, such paperboard cups having a polyethylene extrusion coating have difficulties in recycling and repulping due to difficulty of breaking down or removing the polyethylene film during the re-pulping process, and, thus, are not easily recyclable, causing environmental concerns. Thus, there are increasing demands for alternative solutions including new coating technologies for polyethylene extrusion coated paperboard cups.

Further, many paperboard containers that do not have a polyethylene coating can experience problems with liquid penetration. Liquid penetration can compromise structural integrity of the paperboard container, stain the inner surface of the container, and stain the outer surface of the container. The structural and staining issues may be exacerbated under conditions of elevated temperature, increased air flow, or when aggressive additives are placed in the container such as acidic soda drinks.

Accordingly, those skilled in the art continue with research and development in the field of cellulosic structures.

### SUMMARY

Disclosed are cellulosic structures.

In one example, the disclosed cellulosic structure includes a paperboard substrate having a first surface and a second surface. The cellulosic structure further includes a barrier layer applied to the first surface of the paperboard substrate. The cellulosic structure further includes a release layer positioned between the first surface of the paperboard substrate and the barrier layer. The release layer is water soluble.

Also disclosed are methods for manufacturing a cellulosic structure.

In one example, the disclosed method for manufacturing a cellulosic structure includes steps of (1) applying a coating composition to a first surface of a paperboard substrate; and (2) applying a second coating composition to the first surface of the paperboard substrate to yield the cellulosic structure.

Also disclosed are methods for removing a barrier layer from a cellulosic structure. The cellulosic structure has a release layer positioned between the barrier layer and a first surface of a paperboard substrate of the cellulosic structure.

In one example, the method includes subjecting the cellulosic structure to water.

### BRIEF DESCRIPTION OF THE DRAWINGS

FIG. 1 is a schematic cross-sectional view of an exemplary cellulosic structure;

FIG. 2 a schematic cross-sectional view of another exemplary cellulosic structure;

FIG. 3 a schematic cross-sectional view of another exemplary cellulosic structure;

FIG. 4 a schematic cross-sectional view of another exemplary cellulosic structure;

FIG. 5 a schematic cross-sectional view of another exemplary cellulosic structure;

FIG. 6 is a flow diagram of a method for manufacturing a cellulosic structure;

FIG. 7 is a flow diagram of a method for removing a barrier layer from a cellulosic structure;

FIG. 8 is a graph of experimental polyadhesion data of an exemplary cellulosic structure;

FIG. 9 is graph of experimental edge wick data of an exemplary cellulosic structure;

FIG. 10 is a graph of experimental turbidity data of an exemplary release coating for a cellulosic structure;

FIG. 11 is a graph of experimental turbidity data of an exemplary release coating for a cellulosic structure; and

FIG. 12 is a graph of experimental turbidity data of an exemplary release coating for a cellulosic structure.

### DETAILED DESCRIPTION

The present description relates to cellulosic structures, such as beverage cups, food packaging, and the like that include a paperboard substrate, a release coating, and a barrier coating.

The present disclosure recognizes that cellulosic structures coated with aqueous barrier coatings are generally considered repulpable and recyclable and, thus, more sustainable. However, paper containers, for example cups, made of aqueous coated paperboard do not perform at the same level as cups made of low-density polyethylene (LDPE) extrusion coated paperboard. One of the technical challenges is that the aqueous coated cup bottom may show cracking, beverage staining, and even leaking along a fold edge of the cup bottom. The aqueous coated paperboard cups also may have insufficient heal seal, especially at a joint of a side seam and/or a bottom seam, resulting in channel leaking or seeping of beverage.

Further, many cellulosic structures that have an aqueous barrier coating or even an extrusion coating, can experience problems with liquid or gas penetration, especially when the barrier coating has defects or pinholes. Liquid or gas penetration can compromise structural and/or functional integrity of the paperboard container and/or stain the inner surface of the container. Such staining can show through the outer surface of the container. The structural and staining issues may be exacerbated under conditions of elevated temperature, increased air flow, or when the food or beverage contains aggressive additives or flavor shots.

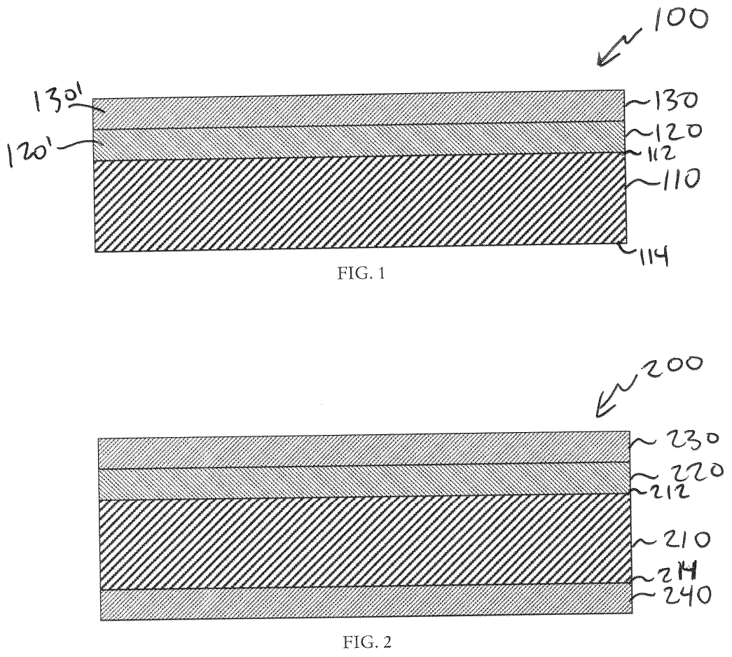

Referring to FIGS. 1-4, by way of examples, the present disclosure is directed to a cellulosic structure 100. The cellulosic structure 100 includes a paperboard substrate 110. The paperboard substrate 110 has a first surface 112 and an opposing second surface 114. The paperboard substrate 110 includes a cellulosic material and may be bleached or unbleached. Examples of the paperboard substrate 110 include, but are not limited to, an uncoated natural kraft (UNK) board, a solid beached sulfate (SBS) board, an uncoated recycled board (URB), a coated white lined chipboard, or an uncoated folding boxboard (FBB). The paperboard substrate 110 may be formed from virgin fibers, recycled fibers, or combinations thereof.

One specific, non-limiting example of the paperboard substrate 110 is 13-point, 150 pounds per 3000 square feet SBS TruServ™ cupstock manufactured by WestRock Company of Atlanta, Georgia. Another specific, nonlimiting example of a suitable cellulosic substrate 110 is 18-point, 185 pounds per 3000 square feet SBS TruServ™ cupstock manufactured by WestRock Company. Yet another example of a suitable cellulosic substrate 110 is 16.5-point, 175 pounds per 3000 square feet TruServ™ poly cupstock manufactured by WestRock Company of Atlanta, Georgia.

Referring to FIG. 1, the cellulosic structure 100 includes a release layer 120. The release layer 120 is dissolvable in water. In one example, the release layer 120 includes a pigment and a binder. In one example, the ratio of pigment to binder in the release layer 120 is about 1 part (by weight) pigment per 1 part (by weight) binder. In one or more examples, the ratio of the pigment to the binder may be about 1:1 to about 1:9 by weight. In one or more examples, the ratio of the pigment to the binder can be about 1:1.5 to about 1:6 by weight. In one or more examples, the ratio of the pigment to the binder can be about 1:2 to about 1:4 by weight. In one, non-limiting example, the pigment comprises approximately 50% of the release layer. In another example, the pigment comprises approximately 80% of the release layer.

The pigment of the release layer 120 may include calcium carbonate, including coarse CaCO₃, fine CaCO₃, or a combination thereof. The release layer 120 may include approximately 50% CaCO₃. approximately 80% CaCO₃, or more than 80% CaCO₃. Other pigments are also contemplated, such as, but not limited to, clay pigment includes kaolin clay, such as a fine kaolin clay. In one or more examples, the clay pigment includes a platy clay, such as a high aspect ratio platy clay (e.g., an average aspect ratio of at least 20:1, an average aspect ratio of at least 25:1, an average aspect ratio of at least 30:1, an average aspect ratio of at least 40:1, an average aspect ratio of at least 50:1, as an average aspect ratio of at least 60:1, etc.) Further, the pigment of the release layer 120 may include both clay pigment and calcium carbonate. Other examples of suitable pigments are also contemplated, such as, but not limited to, inorganic pigments, plastic pigments, titanium dioxide pigments, talc pigment, and the like or combinations thereof.

The binder of the release layer 120 may be soluble and include starch, ethylated starch, hydrophobic starch, maize starch (e.g., 100% hydrophobically modified waxy maize starch), potato starch, or a combination thereof. Other aqueous binders are also contemplated, such as, but not limited to, polyvinyl alcohol.

The release layer 120 may be applied at any suitable coat weight. In one example, the release layer 120 is applied at a coat weight ranging from about 1 pound per 3000 ft² to about 10pounds per 3000 ft². In another example, the release layer 120 is applied at a coat weight of about 8.5 pounds per 3000 ft². In yet another example, the release layer 120 is applied at a coat weight of about 2 pounds per 3000 ft².

Referring to FIG. 1, the cellulosic structure 100 includes a barrier layer 130. The barrier layer 130 may be applied onto the release layer 120 of the cellulosic structure 100 such that the release layer 120 is positioned between the barrier layer 130 and the first surface 112 of the paperboard substrate. The barrier layer 130 may be a polymer. In one example, the barrier layer 130 includes low density polyethylene (LDPE), high density polyethylene (HDPE), polylactic acid (PLA), polyethylene terephthalate (PET) or any combination thereof. The barrier layer 130 may be extruded over the release layer 120. In one example, the barrier layer 130 is heat sealable.

The barrier layer 130 may be applied at any suitable coat weight. In one example, the barrier layer 130 has a coat weight of about 0.25 mil to about 1.5 mil. In another example, the barrier layer 130 has a coat weight of about 0.5 mil to about 1 mil. In yet another example, the barrier layer 130 has a coat weight of about 0.75 mil.

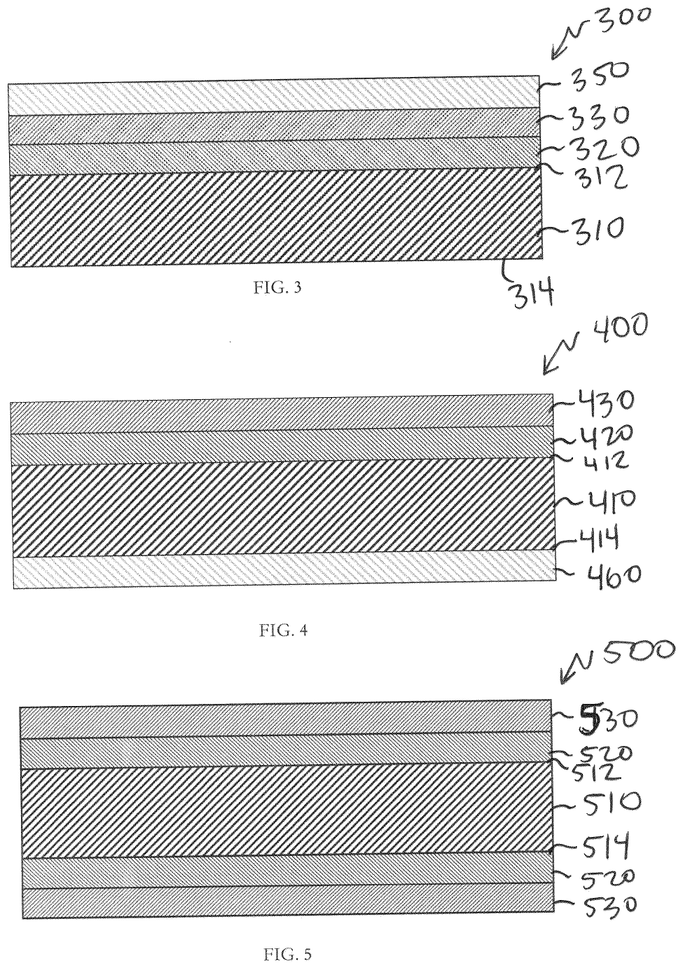

Referring to FIG. 2, a cellulosic structure 200 includes a paperboard substrate 210 having a first surface 212 and an opposing second surface 214. A release layer 220 is applied to the first surface 212 of the paperboard substrate 210 such that it is positioned between a barrier layer 230 and the first surface 212. A second barrier layer 240 is applied to the second surface 214 of the paperboard substrate.

Referring to FIG. 3, a cellulosic structure 300 includes a paperboard substrate 310 having a first surface 312 and an opposing second surface 314. A release layer 320 is applied to the first surface 312 of the paperboard substrate 310 such that it is positioned between a barrier layer 330 and the first surface 312. Optionally, the cellulosic structure 300 may include a top coat 350 applied to the first surface 312 of the paperboard substrate 310 and/or to the second surface 314 of the paperboard substrate 310.

Referring to FIG. 4, a cellulosic structure 400 includes a paperboard substrate 410 having a first surface 412 and an opposing second surface 414. A release layer 320 is applied to the first surface 412 of the paperboard substrate 410 such that it is positioned between a barrier layer 430 and the first surface 412. Optionally, the cellulosic structure 400 may include a base coating 460 applied to the first surface 412 of the paperboard substrate 410 and/or to the second surface 414 of the paperboard substrate 410. Further, the cellulosic structure 400 may include both a top coat 350 and a base coating 460 applied to the first surface 412, the second surface 414, or both the first surface 412 and the second surface 414 of the paperboard substrate 410.

Referring to FIG. 5, a cellulosic structure 500 includes a paperboard substrate 510 having a first surface 512 and an opposing second surface 514. A release layer 520 is applied to the first surface 512 of the paperboard substrate 510 such that it is positioned between a barrier layer 530 and the first surface 512. Optionally, the cellulosic structure 500 may include another release layer 520 and barrier layer 530 applied to the second surface 514 of the paperboard substrate 510 such that the release layer 520 of the second surface 514 is positioned between a barrier layer 530 and the second surface 514. In one example, the release layer 520 on the first surface 512 is compositionally substantially the same as the release layer 520 on the second surface 514. In another example, the release layer 520 on the first surface 512 is compositionally different from the release layer 520 on the second surface 514 such that they dissolve at different rates. For example, the release layer 520 on the first surface 512 may quickly dissolve and the release layer 520 on the second surface 514 may dissolve at a slower rate as water penetrates the paperboard substrate 510 from the first surface 512. Further, the barrier layer 530 on the first surface 512 may be compositionally substantially the same as the barrier layer 530 on the second surface 514 or, contrarily, may be compositionally different than the barrier layer 530 on the second surface 514.

The cellulosic structure 100 described herein shows improved repulpability performance compared to conventional paperboard containers (e.g., cups) having the polyethylene extrusion coating applied directly to a surface of the paperboard substrate 110. The release layer 120 promotes recyclability by providing a means of easily removing a non-recyclable polymer barrier layer 130, such as polyethylene, prior to further processing of the paperboard substrate 110 for recycling. In one or more examples, the cellulosic structure 100 has a repulpability yield of 75% accepts or greater, preferably 80% accepts or greater, more preferably 85% accepts or greater, more preferably 90% accepts or greater.

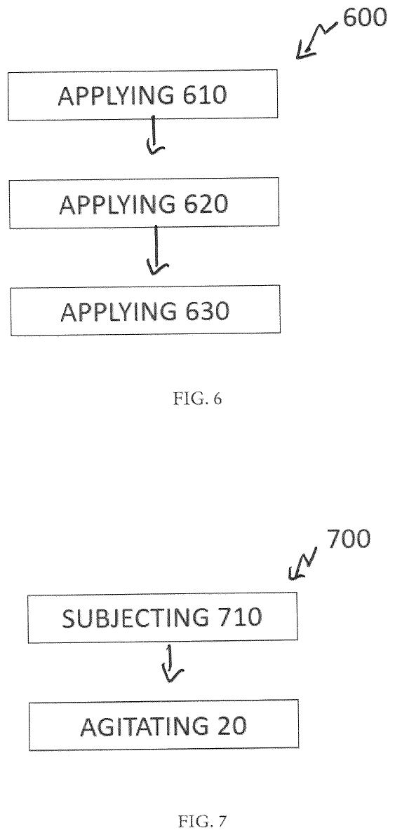

Referring to FIG. 6, disclosed is a method 600 for manufacturing a cellulosic structure 100. The cellulosic structure 100 includes a paperboard substrate 110, a release layer 120, and a barrier layer 130. The paperboard substrate 110 includes a cellulosic material and may be bleached or unbleached. Examples of the paperboard substrate 110 include, but are not limited to, an uncoated natural kraft (UNK) board, a solid beached sulfate (SBS) board, an uncoated recycled board (URB), a coated white lined chipboard, or an uncoated folding boxboard (FBB). The paperboard substrate 110 may be formed from virgin fibers, recycled fibers, or combinations thereof.

One specific, non-limiting example of the paperboard substrate 110 is 13-point, 150pounds per 3000 square feet SBS TruServ™ cupstock manufactured by WestRock Company of Atlanta, Georgia. Another specific, nonlimiting example of a suitable cellulosic substrate 110 is 18-point, 185 pounds per 3000 square feet SBS TruServ™ cupstock manufactured by WestRock Company. Yet another example of a suitable cellulosic substrate 110 is 16.5-point, 175 pounds per 3000 square feet TruServ™ poly cupstock manufactured by WestRock Company of Atlanta, Georgia.

In one example, the method 600 incudes applying 610 a coating composition 120′ to a first surface 112 of the paperboard substrate 110 to yield a release layer 120. The coating composition 120′ includes a pigment and a binder. The pigment of the coating composition 120′ may include coarse CaCO3, fine CaCO3, or a combination thereof. The binder of the coating composition 120′ may be soluble and include ethylated starch, hydrophobic starch, 100% hydrophobically modified waxy maize starch, or a combination thereof.

The coating composition 120′ may be applied at a coat weight ranging from about 1 pound per 3000 ft² to about 10 pounds per 3000 ft². In another example, the coating composition 120′ may be applied at a coat weight of about 8.5 pounds per 3000 ft². In yet another example, the coating composition 120′ may be applied at a coat weight of about 2 pounds per 3000 ft².

Referring to FIG. 6, the method 600 further includes applying 620 a second coating composition 130′ to the first surface 112 of the paperboard substrate 110 to yield a barrier layer of the paperboard substrate 110. The second coating composition 130′ includes a polymer. The polymer of the second coating composition 130′ may include low density polyethylene (LDPE), high density polyethylene (HDPE), polylactic acid (PLA), polyethylene terephthalate (PET) or any combination thereof. In one example, the applying 620 includes extruding the second coating composition 130′ over the release layer 120 formed by first coating composition 120′. In one example, the barrier layer 130 is heat sealable.

The second coating composition 130′ may be applied at a coat weight of about 0.25 mil to about 1.5 mil. In another example, the second coating composition 130′ may be applied at a coat weight of about 0.5 mil to about 1 mil. In one non-limiting example, the second coating composition 130′ is applied at a coat weight of about 0.75 mil.

The method 600 may further include applying 630 the second coating composition 130′ to a second surface 114 of the paperboard substrate 110 to yield a second barrier layer 240. In one example, the applying 620 includes extruding the second coating composition 130′ over the second surface 114 of the paperboard substrate 110. In one example, the second barrier layer 240 is heat sealable.

Referring to FIG. 7, disclosed is a method 700 for removing a barrier layer 130 from a cellulosic structure 100. The cellulosic structure 100 includes a paperboard substrate 110 having a release layer 120 positioned between the barrier layer 130 and a first surface 112 of the paperboard substrate 110.

In one example, the method 700 includes subjecting 710 the cellulosic structure 100 to water. The water may be heated to a temperature of about 100° F. to about 200° F. In another example, the water may be heated to a temperature of about 150° F.

Referring to FIG. 7, the method 700 may further include agitating 720 the cellulosic structure 100. The agitating 720 may occur simultaneously with the subjecting 710 the cellulosic structure 100 to water. The agitating 720 may include stirring the cellulosic structure 100 with a magnetic stirring bar while immersed in heated water.

At this point, those skilled in the art will appreciate that various layers may be incorporated into the various examples of the disclosed paperboard substrates 110, 210, 310 and 410 described herein to form the various examples of the cellulosic structures 100, 200, 300 and 400 without departing from the scope of the present disclosure.

### EXPERIMENTAL EXAMPLES

Experiments were conducted to evaluate the use of a cellulosic structure 100 having a paperboard substrate 110 with a release layer 120 applied to a first surface 112 of the paperboard substrate 110 and a barrier layer 130 applied to the release layer 120. The compositions of each cellulosic structure and the applied release and barrier layers are shown in Table 1 below.

TABLE 1

| | | Number | Rough | | Rough Side | | | Smooth Side |
|---|---|---|---|---|---|---|---|---|
| | | of | Side | | Coat Wgt | Smooth Side | | Coat Wgt |
| Sample # | Color | Lines | Coating | Rough Side Coating | (lb/3MSF) | Coating | Smooth Side Coating | (lb/3MSF) |
| 2025-1 | None | None | None | It's uncoated | n/a | None | It's uncoated | n/a |
| 2025-2 | None | None | None | It's uncoated | n/a | CC-1 | Ethylated starch with | Various: |
| | | | | | | | 20prts fine CaCO3 | 0 to 1.6 |
| 2027-1 | Black | single | BC-1 | Coarse CaCO3 with | 6.0 | CC-1 | Ethylated starch with | 1.6 |
| | | | | ethylated starch | | | 20prts fine CaCO3 | |
| 2027-2 | Black | double | BC-1 | Coarse CaCO3 with | 8.4 | CC-1 | Ethylated starch with | 1.6 |
| | | | | ethylated starch | | | 20prts fine CaCO3 | |
| 2027-3 | Black | triple | BC-1 | Coarse CaCO3 with | 9.9 | CC-1 | Ethylated starch with | 1.6 |
| | | | | ethylated starch | | | 20prts fine CaCO3 | |
| 2028-1 | Green | single | BC-2 | Hydrophobic starch with | 1.7 | CC-1 | Ethylated starch with | 1.6 |
| | | | | 20prts fine CaCO3 | | | 20prts fine CaCO3 | |
| 2028-2 | Green | double | BC-2 | Hydrophobic starch with | 3.8 | CC-1 | Ethylated starch with | 1.6 |
| | | | | 20prts fine CaCO3 | | | 20prts fine CaCO3 | |
| 2029-1 | Red | single | BC-3 | Coarse CaCO3 with PVAc | 4.7 | CC-1 | Ethylated starch with | 1.6 |
| | | | | | | | 20prts fine CaCO3 | |
| 2029-2 | Red | double | BC-3 | Coarse CaCO3 with PVAc | 7.4 | CC-1 | Ethylated starch with | 1.6 |
| | | | | | | | 20prts fine CaCO3 | |
| 2029-3 | Red | triple | BC-3 | Coarse CaCO3 with PVAc | 9.8 | CC-1 | Ethylated starch with | 1.6 |
| | | | | | | | 20prts fine CaCO3 | |
| Mill-Control | None | None | Mill-Made | Tango Board | ~15 | Curl Mix | Standard curl mix | Standard |

The poly coated samples were evaluated for dry poly adhesion and the speed at which the poly was removed when soaked in hot water, for example 150° F., and gently mixed with a magnetic stirring bar. Samples having a release layer positioned between the paperboard substrate and polymer barrier layer exhibited a dry adhesion was as good or better than the control, but the polymer quickly came off when exposed to the hot water with agitation. Samples of the board were exposed to jungle chamber conditions for two weeks, and poly adhesion remained good. Heat and humidity alone were not enough to cause the poly to release. It took hot water and some agitation. Coffee cups were made with the cellulosic structure and were tested with hot coffee and creamer. The release poly cups performed well, and they had as good or better edge wicking performance compared to the control cups.

A 90° polyadhesion test was performed to measure the peel adhesion strength of the polymer barrier layer extruded to the release layer 120 of the paperboard substrate 110. The test of the adhesion of poly-extruded samples included using 3M™ Scotch 250 Yellow Tape and a 90° rotating German peel wheel.

The goal of the 90° peel poly adhesion test method was to measure the adhesion & bond strength of the polymer film that is extrusion coated onto the paperboard, while remaining a constant 90° peel angle using a Rotating German Wheel Peel fixture. Samples were cut & measured from extrusion coated paperboard. Five samples, per condition, were cut into 1″×5″ strips. This includes the 1″ area of the LDPE on a slip sheet, that was inserted during the extrusion process. This slip sheet aids in releasing the polymer partially from the board. A single-sided adhesive tape of 10″ in length was then laid directly on top of each sample with a long tail overhang to help serve as a pulling tab for the upper grip clamp on the Instron. A double-sided adhesive tape of 5″ in length was placed on the bottom of each sample. Samples are then attached to the rotating German wheel peel for testing with the free end of the sample inserted into upper grip clamp of the Instron. The crosshead is then driven in the machine tensile direction going up at 1″ crosshead speed per minute. The tape with LDPE adhered, is then peeled from the wheel at a constant 90° degree angle. The displacement occurs over 3″-4″. The force required to peel the tape is monitored by the load, providing a direct measurement of bond strength. Samples were tested & recorded with a Max Load per Width & an Average Load per Width in pound per force (lbf).

Samples tested for polyadhesion were subjected to TAPPI standard conditions for at least 12 hours prior to testing. Samples were cut along the machine direction (MD) on the paperboard (1″×5″ inch each strips). Using a 1″ width precision cutter, five samples were cut to 1 inch wide and at least 4 inch in length of poly coat onto board (measuring from the slip sheet) and at least 1 inch of the poly on slip sheet, thus 5 inches in total length. Approximately 10″ of 3M 250 yellow tape was cut and applied over the sample such that a long tail remained hanging over the end of the sample. Part of the yellow tape was folded over itself to assist pulling with the upper grip clamp on the Instron™.

The sample was then attached to the rotating German peel wheel using the double sided tape. The tape was pulled towards the top of the clamp, thus pulling the poly, or barrier layer, off of the slip sheet. The sample was mounted onto the Instron™. The samples were tested under the following conditions: load cell of 5 kNn, gauge length of 1 to 2 includes (90 degrees), rate of 1 in/min, test limit displacement of 3 to 4 inches, a top pneumatic serrated hand clamp, and a bottom rotating German peel wheel clamp.

Experimental results of the tests are shown in TABLE 2 and TABLE 3 below, and in FIG. 7 of the drawings. Of the samples tested, all five of the 2025-1LD samples exhibited complete fiber tear. All five of the 2027-1 LD samples tested exhibited a poly break at the initiation point. Similarly, all five 2027-2 LD samples tested exhibited a poly break at the initiation point. Two of the 2027-3 LD samples exhibited a partial fiber tear while the other three exhibited a poly break at the initiation point. One of the 2028-1 LD samples exhibited a partial fiber tear while the other four exhibited a poly break at the initiation point. Two of the 202802 LD samples exhibited a partial fiber tear while the other three exhibited a poly break at the initiation point. All five of the 2029-1 LD and 2029-2 LD samples tested exhibited a poly break at the initiation point. One of the 2029-3 LD samples exhibited no fiber tear while the other four exhibited a poly break at the initiation point. Finally, none of the mill control samples exhibited a fiber tear.

TABLE 2
Max Load Load per 1 Inch Width @ 1 Inch Crosshead Speed/Minute

| Max Load/ | | | | | | | | | | |
|---|---|---|---|---|---|---|---|---|---|---|
| Width | 2025-1 | 2027-1 | 2027-2 | 2027-3 | 2028-1 | 2028-2 | 2029-1 | 2029-2 | 2029-3 | Mill- |
| (lbf/in) | LD | LD | LD | LD | LD | LD | LD | LD | LD | Control |
| 1 | 1.79898 | 2.50386 | 2.55088 | 2.47055 | 3.04046 | 3.27917 | 2.96479 | 2.57180 | 3.33488 | 1.04120 |
| 2 | 1.77895 | 2.22218 | 2.51415 | 2.57856 | 2.83526 | 3.38648 | 3.25454 | 2.53606 | 3.80701 | 0.79728 |
| 3 | 1.76908 | 2.40710 | 2.32696 | 3.03890 | 3.18573 | 2.89935 | 2.96862 | 2.52931 | 3.58361 | 0.77380 |
| 4 | 1.90772 | 2.46957 | 2.39682 | 3.50950 | 3.34038 | 3.48678 | 2.66248 | 2.69296 | 2.75956 | 0.81291 |
| 5 | 1.69379 | 2.38099 | 2.32610 | 3.40112 | 3.16203 | 3.32512 | 2.83107 | 3.0949 | 3.46724 | 0.81878 |
| Mean | 1.790 | 2.397 | 2.423 | 3.000 | 3.113 | 3.275 | 2.936 | 2.685 | 3.390 | 0.849 |
| S.D. | 0.08 | 0.11 | 0.10 | 0.47 | 0.19 | 0.22 | 0.22 | 0.24 | 0.39 | 0.11 |
| Std. Error | 0.03 | 0.05 | 0.05 | 0.21 | 0.08 | 0.10 | 0.10 | 0.11 | 0.18 | 0.05 |

TABLE 3
Average Load Load per 1 Inch Width @ 1 Inch Crosshead Speed/Minute

| Avg. Load/ | | | | | | | | | | |
|---|---|---|---|---|---|---|---|---|---|---|
| Width | 2025-1 | 2027-1 | 2027-2 | 2027-3 | 2028-1 | 2028-2 | 2029-1 | 2029-2 | 2029-3 | Mill- |
| (lbf/in) | LD | LD | LD | LD | LD | LD | LD | LD | LD | Control |
| 1 | 0.8656 | 2.0110 | 1.9399 | 1.6353 | 2.007 | 2.1007 | 1.9706 | 1.8534 | 2.1236 | 0.9381 |
| 2 | 0.7818 | 1.7823 | 1.913 | 1.0685 | 2.0285 | 2.0244 | 2.1184 | 1.9708 | 2.7196 | 0.6978 |
| 3 | 0.8255 | 1.8147 | 1.8543 | 2.0384 | 1.4848 | 2.0585 | 2.0784 | 1.9334 | 2.1700 | 0.6869 |
| 4 | 0.8343 | 1.9602 | 1.8386 | 2.0361 | 2.1390 | 1.8249 | 1.9082 | 1.9115 | 2.1527 | 0.7190 |
| 5 | 0.7816 | 1.8733 | 1.8906 | 2.0453 | 2.1101 | 1.9836 | 1.9829 | 1.8965 | 2.3821 | 0.7425 |
| Mean | 0.757 | 1.888 | 1.887 | 1.765 | 1.954 | 1.998 | 2.012 | 1.913 | 2.310 | 0.757 |
| S.D. | 0.10 | 0.10 | 0.04 | 0.43 | 0.27 | 0.11 | 0.09 | 0.04 | 0.25 | 0.10 |
| Std. Error | 0.05 | 0.04 | 0.02 | 0.19 | 0.12 | 0.05 | 0.04 | 0.02 | 0.11 | 0.05 |

Test results were able to demonstrate peel adhesion & bond strength of LDPE that has been extrusion coated onto release coated properties of cupstock paperboard. The peel force required to show fiber tear in 2025-1 LD was greater than the Mill control, that did not exhibit any fiber tear or good bonding. In certain conditions like that of 2027-1 LD to 2029-4 LD, the release coat/LDPE would break at the starting point as a majority failure. The values showed a strong peel force. This indicated values of the tape peeling alone, without the release coat/LDPE. The adhesion to the paperboard was strong and continued to maintain good adhesion. Partial fiber tear was observed in the 2027-3 LD to 2028-2 LD.

Approximately 10 g of samples cut into 1″×1″ squares were placed in a 2,000 mL beaker with 1,000 mL of water set to 150° F. stirring at 600 RPM for 15 minutes. Samples were allowed to float & stir freely without any outside force applied. Observations were made during the 15 minutes as to condition of the water & condition of the sample. When poly is first observed floating freely in the water, that time is recorded. When the 15 minutes is up, the beaker is drained, and the sample squares are hand separated into 3 categories: 1. Poly still attached, 2.board only, & 3. poly only. Separation percentage is estimated based on the ratio of board only squares to squares with poly still attached. On average, there are 50 squares in a batch to make up the 10 g of sample. Speed of removal data is illustrated in Table 4 below.

TABLE 4

| | | Time First Poly | |
|---|---|---|---|
| | Separation | Observed | |
| Sample # | Percentage | separated | |
| 2025-1 | 0% | N/A | |
| 2027-2 | ~80% | 13 | min |
| 2027-3 | ~75% | 9 min. | 45 sec. |
| 2028-1 | 90-95% | 11 min. | 30 sec. |
| 2028-2 | 100% | 5 | min. |
| 2029-3 | 0% | N/A | |
| Mill-Control | 66%-75% | 8 | min. |

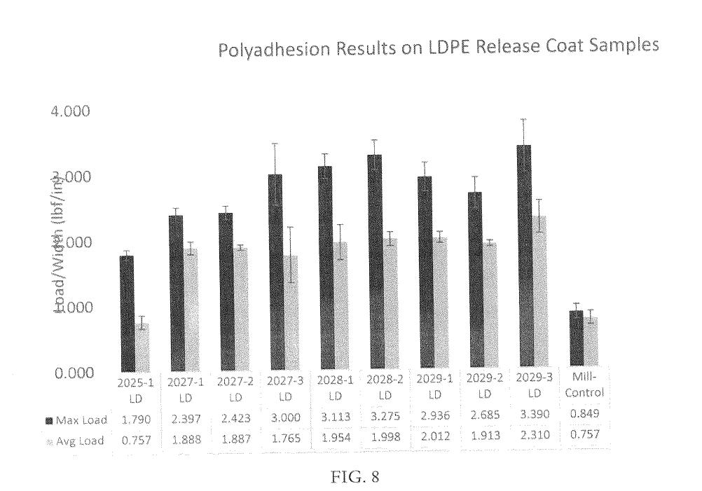

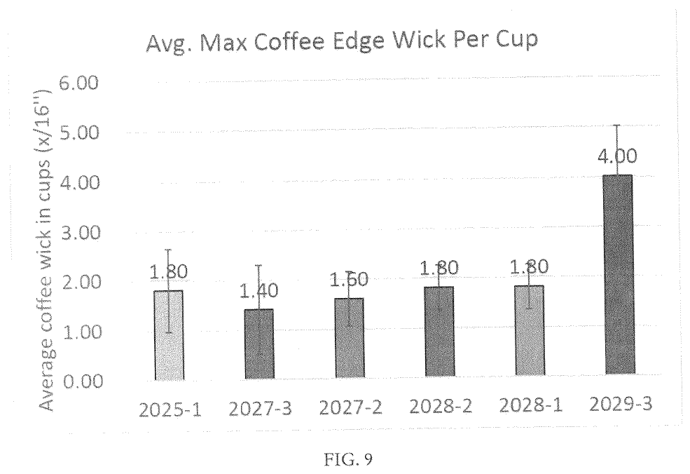

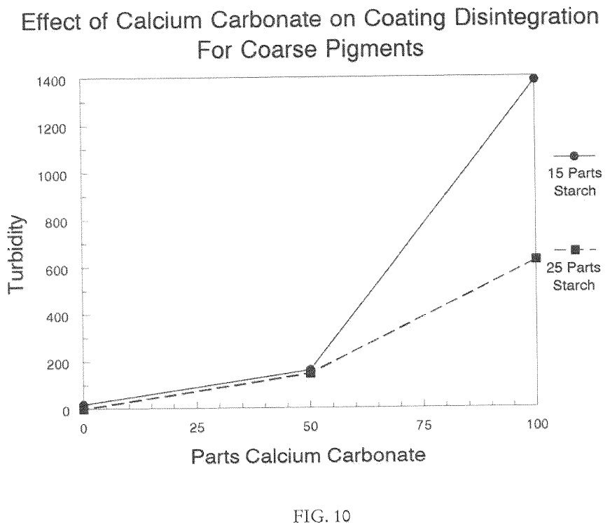

Further experimental testing included edge wick testing. Samples of the extruded board were tested according to the Westrock Coffee Edge Wick Test. 1″ wide strips cut from the board, the backside is taped over with a specific 3M tape and samples are placed in a pot of Starbucks coffee with Rich's Creamer for 30 minutes. Samples are removed, dried, and the edge wick is measured. Edge wick is the measurement of how deep into the side of the cup that the coffee was able to travel. Edge wick takes place at the interface of the board & poly (LDPE) extruded coating. Edge wick was measured in 1/16ths of an inch. As shown in FIG. 8 of the drawings, the control, Cupstock with no Coating & extruded with LDPE, was outperformed by both coat weights of the 2027 coating and performed the same as both 2028 coating coat weights. FIG. 9 illustrates edge wick data collected during testing.

Additional experimental testing included Coating Disintegration testing. The Coating Disintegration testing conducted evaluated and compared the degree of disintegration each coating experienced when rewetted. Turbidity, a measurement commonly used to measure the “cloudiness” of a liquid, was measured. In the current experimental tests, turbidity measured the amount of the coating that gets redispersed in the water. A low number represents low dispersed particle content. Three experimental tests under the same conditions were conducted. An ethylated starch (Ethylex 2015) was jet cooked and used as the binder for all coatings. Coatings consisted only of pigment and starch. All coatings were made at about 57% solids concentration.

Silicone trays with molds that are 1.5×1.5 inch square by 1 inch deep were used to make dried wafers of coating. For each sample, 10 grams of coating were placed in a mold. Five molds were made for each condition. Trays were dried for 16 hours at 302° F. then cured at 220° F. for 3 hours. Each wafer was tested by the following method. A 500 ml bottle was filled with 300 g of distilled water. A wafer was added to the bottle, then the bottle was placed on a bottle roller for 15 minutes. A sample of the supernatant liquid was removed and tested for turbidity. Turbidity was tested according to ISO method 7027, and the unit for turbidity is the Formazin Nephelometric Unit. A value of 0-10 looks clear to the naked eye. Values of 500 or greater look milky and opaque to the naked eye.

The first experiment compared coatings made using 100% of either a coarse ground calcium carbonate (Hydrocarb 60 from Omya) or a coarse clay (Kaobrite from Thiele). Also tested included a 50/50 blend of coarse ground calcium carbonate and coarse clay. Coatings with both 15 and 25 parts starch as binder were tested. The results are illustrated in Table 5 below and FIG. 10 of the drawings.

TABLE 5

| | 15 parts | 25 parts |
|---|---|---|
| All-carbonate | 1382.6 | 623.8 |
| 50/50 blend | 160 | 145 |
| All-clay | 18 | 0 |

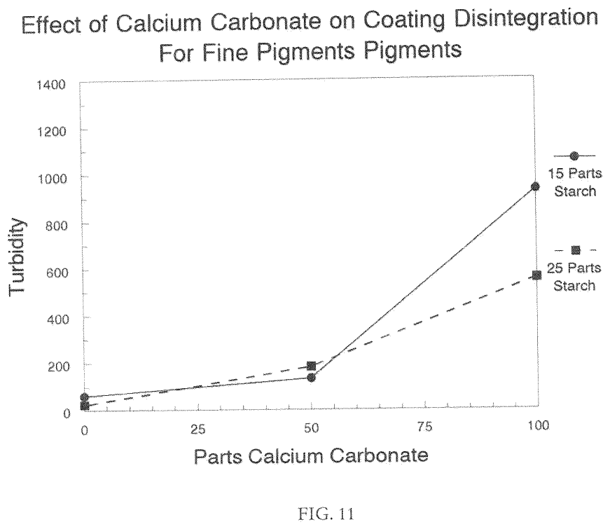

An all-clay coating exhibits very low turbidity. The turbidity increases as the calcium carbonate content increases, regardless of binder content. This evidently demonstrates the effect of calcium carbonate on the disintegration of a starch-bound coating. This experiment was repeated using fine pigments. The calcium carbonate was Hydrocarb 90 from Omya and the clay was Kaofine 91 from Thiele. Table 6 below and FIG. 11 of the drawings show that the fine pigments yielded very similar results.

TABLE 6

| | 15 parts | 25 parts |
|---|---|---|
| All-carbonate | 928.6 | 553.4 |
| 50/50 blend | 132.2 | 182 |
| All-clay | 60.6 | 23.75 |

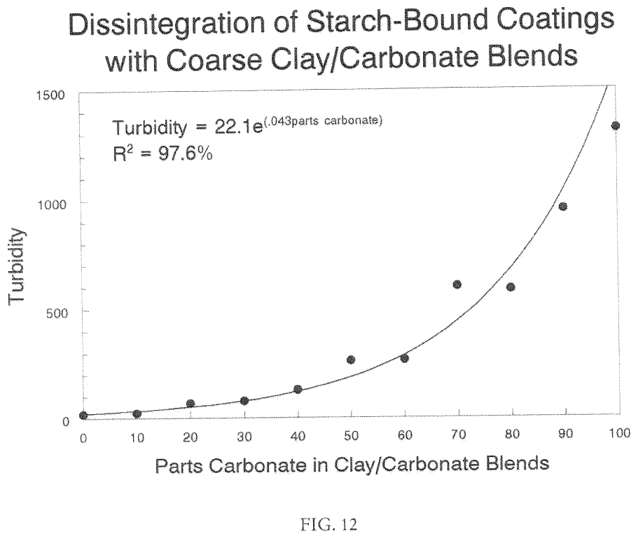

The third experiment used the same pigments as the first with 20 parts starch as binder using a more detailed series of pigment blends. Table 7 and FIG. 12 of the drawings illustrate that disintegration increased as an exponential function of carbonate content.

TABLE 7

| Carbonate | Clay | Turbidity |
|---|---|---|
| 100 | 0 | 1314 |
| 90 | 10 | 951.2 |
| 80 | 20 | 584.4 |
| 70 | 30 | 598.75 |
| 60 | 40 | 266.8 |
| 50 | 50 | 263.4 |
| 40 | 60 | 130.2 |
| 30 | 70 | 79.6 |
| 20 | 80 | 69.4 |
| 10 | 90 | 24.32 |
| 0 | 100 | 18.8 |

Although various examples of the disclosed cellulosic structures, methods for manufacturing a cellulosic structure, and methods for removing a barrier layer from a cellulosic structure have been shown and described, modifications may occur to those skilled in the art upon reading the specification. The present application includes such modifications and is limited only by the scope of the claims.

1. A cellulosic structure comprising:
a paperboard substrate having a first surface and a second surface;
a barrier layer positioned over the first surface of the paperboard substrate; and
a release layer positioned between the barrier layer and the first surface of the paperboard substrate, wherein the release layer is water soluble.

2. The cellulosic structure of claim 1, wherein the release layer comprises a pigment.

3. The cellulosic structure of claim 2, wherein the pigment comprises coarse CaCO₃.

4. (canceled)

5. The cellulosic structure of claim 2, wherein the pigment comprises about 50% CaCO₃.

6. The cellulosic structure of claim 2, wherein the pigment comprises about 80% CaCO₃.

7. The cellulosic structure of claim 1, wherein the release layer comprises a soluble binder.

8. The cellulosic structure of claim 7, wherein the soluble binder comprises starch.

9. The cellulosic structure of claim 7, wherein the soluble binder comprises at least one of ethylated starch and hydrophobically modified waxy maize starch.

10. The cellulosic structure of claim 1, wherein the release layer comprises:
a pigment; and
a soluble binder, wherein a ratio of pigment to soluble binder is about 1:1 to about 1:9 by weight.

11. The cellulosic structure of claim 1, wherein the barrier layer comprises a polymer.

12. The cellulosic structure of claim 1, wherein the barrier layer comprises low density polyethylene.

13. The cellulosic structure of claim 1, wherein the barrier layer comprises polylactic acid.

14. The cellulosic structure of claim 1, wherein the barrier layer is heat sealable.

15. The cellulosic structure of claim 1, wherein the release layer has a coat weight ranging from about 1 pound per 3000 ft² to about 10 pounds per 3000 ft².

16-17. (canceled)

18. The cellulosic structure of claim 1, wherein the barrier layer has a coat weight of about 0.25 mil to about 1.5 mil.

19. The cellulosic structure of claim 1, wherein the barrier layer has a coat weight of about 0.5 mil to about 1 mil.

20. (canceled)

21. The cellulosic structure of claim 1, wherein the paperboard substrate comprises solid bleached sulfate.

22. A paperboard cup comprising the cellulosic structure of claim 1.

23. A method for manufacturing a cellulosic structure, the method comprising:
applying a coating composition to a first surface of a paperboard substrate; and
applying a second coating composition to the first surface of the paperboard substrate to yield the cellulosic structure.

24-42. (canceled)

43. A method for removing a barrier layer from a cellulosic structure, the cellulosic structure having a release layer positioned between the barrier layer and a first surface of a paperboard substrate of the cellulosic structure, the barrier layer comprising a polymer, the method comprising:
subjecting the cellulosic structure to water.

44-46. (canceled)
